(19) United States
(12) Patent Application Publication
(10) Pub. No.: US 2022/0036211 A1
(43) Pub. Date: Feb. 3, 2022

(54) USER-HESITANCY BASED VALIDATION FOR VIRTUAL ASSISTANCE OPERATIONS

(71) Applicant: International Business Machines Corporation, Armonk, NY (US)

(72) Inventors: Zachary A. Silverstein, Jacksonville, FL (US); Trudy L. Hewitt, Cary, NC (US); Liam S. Harpur, Dublin (IE); Jonathan D. Dunne, Dungarvan (IE)

(21) Appl. No.: 16/942,896

(22) Filed: Jul. 30, 2020

(51) Int. Cl. G06N 5/04; G06F 16/23; G06F 9/451; G06N 3/00

(52) U.S. Cl. CPC G06N 5/04; G06N 3/006; G06F 9/453; G06F 16/2379

(57) ABSTRACT

A system determines if a user is hesitating when inputting a command based on a time delay. The system determines a severity value based on the hesitancy, and further determines whether or not to prompt the user to validate the command based (at least in part) on the severity value.

### BACKGROUND

The Internet of Things (IOT) is a rapidly expanding field of technology. In general, IOT refers to household devices enhanced with network functionality. This can enable, for example, a user to turn their household lights on or off via an app on the user's mobile device (the user may not even need to be present at the household). Other common examples of IOT devices include security systems (such as cameras), televisions, thermostats, etc.

Virtual assistants (or virtual agents) can serve as a centralized control center for a network of interconnected IOT devices. A virtual assistant can, for example, allow a user to check their bank statement and then, seconds later, start an oven and turn a television on. Virtual assistants often provide significant flexibility and ease of use in the form of a single point of control for a variety of devices. Many virtual assistants are enabled to perform these sorts of functions in response to voice commands.

### SUMMARY

Some embodiments of the present disclosure can be illustrated as a method. The method includes receiving a command from a user. The method also includes calculating a hesitancy of the user based on a time delay of the command. The method also includes calculating a severity value of the command based on the hesitancy. The method also includes determining whether a validation of the command is implemented based on the severity. The method also includes prompting the user to validate the command if a validation is implicated.

Some embodiments of the present disclosure can also be illustrated as a computer program product comprising a computer readable storage medium having program instructions embodied therewith, the program instructions executable by a computer to cause the computer to perform the method discussed above.

Some embodiments of the present disclosure can be illustrated as a system. The system may comprise memory and a central processing unit (CPU). The CPU may be configured to execute instructions to perform the method discussed above.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure. Features and advantages of various embodiments of the claimed subject matter will become apparent as the following Detailed Description proceeds, and upon reference to the drawings, in which like numerals indicate like parts, and in which:

FIG. 1 illustrates a high-level hesitancy-based validation method consistent with several embodiments of the present disclosure;

FIG. 2 illustrates an example method of calculating a “severity value” of a received command based upon multiple factors, consistent with several embodiments of the present disclosure;

FIG. 3 illustrates an example internet-of-things (IOT) environment 300 which may be managed using hesitancy-based command validation, consistent with several embodiments of the present disclosure;

FIG. 4 depicts a cloud computing environment according to an embodiment of the present disclosure;

FIG. 5 depicts abstraction model layers according to an embodiment of the present disclosure; and

FIG. 6 illustrates a high-level block diagram of an example computer system that may be used in implementing embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to systems and methods to determine whether to validate a user command. More particular aspects relate to a system to receive a user command, calculate a hesitancy of the user, and determine, based on the hesitancy, whether to prompt the user to validate the command.

Throughout this disclosure, reference is made to one or more “virtual assistants” or “VAs.” As used herein, a VA refers to a computer-based system to receive, interpret, and execute user commands. For example, a VA may be configured with one or more microphones to listen for user voice commands. A VA may be integrated into one or more user devices, such as, for example, internet of things (IOT)-enabled devices. This way, a user may control multiple devices via a single VA. However, some VAs may also be standalone; they may be restricted to a single device or function.

Throughout this disclosure, reference is made to “user hesitancy.” As used herein, hesitancy refers to a metric to represent a user's confidence in a command. For example, a determination that a user is exhibiting relatively high hesitancy when issuing a command may indicate that the user is unsure about the command. Hesitancy may be calculated as a “hesitancy score,” stored as a number.

Hesitancy may be determined based on, for example, a time delay detected during the user's issuance of the command. As used herein, a “time delay” refers to a length of time elapsed while a user is issuing a command. Example time delays include pauses, filler words (such as “um” or “uh” for voice commands), etc. For example, a user may instruct a VA to set an oven to heat to a particular temperature, but the user may pause prior to stating the temperature itself. In some embodiments, this may indicate that the user is unsure of the temperature to set the oven to, and the longer the pause, the higher the calculated hesitancy score. As a clarifying example, a user may state “VA, set the oven to,” then pause for several seconds, then state “. . . six hundred degrees.” The several-second time delay may indicate that the user does not actually want to set the oven to six hundred degrees. Thus a VA may, in accordance with some embodiments of the present disclosure, prompt the user to confirm the temperature. In contrast, if the user simply states “VA, set the oven to six hundred degrees” (without a pause), then the user's hesitancy score would be lower.

In some embodiments, hesitancy score may be calculated based on an overall duration of a command instruction. In other words, in some embodiments, hesitancy score can be calculated even without detecting a pause or filler word in a command. Instead, hesitancy score can be calculated based on an amount of time it takes the user to state, for example, “VA, set the oven to six hundred degrees.”

Systems and methods consistent with the present disclosure may utilize a calculated hesitancy score (in combination with other factors) to determine whether to prompt a user to validate the command. This determination is also referred to herein as determining whether a validation is “necessary” or “implicated” (for example, if a validation is implicated, a system may prompt the user). This may include determining and/or calculating a “severity” value, a numerical representation of a need to validate a command. A severity value of a command may be determined based on factors such as, for example, the user hesitancy, a likelihood that prompting the user to validate the command may result in the user reversing, cancelling or otherwise modifying the command, a security level of the command, etc.

Other factors besides hesitancy may also be considered when determining a severity value for a command. For example, systems and methods consistent with the present disclosure may consider a security rating of the command, historical data, contextual information, etc. For example, some commands may be considered higher-risk (such as, for example, a command to transfer funds from a bank account to another party) while other commands may be considered lower-risk (such as, for example, a command to turn household lights on). Hesitancy score calculated for a particular command may be weighted based upon the security rating of the command, possibly resulting in different outcomes even for the same hesitancy. For example, a time delay of three seconds detected during a command to transfer funds may result in a system deciding to prompt the user to validate the command, while the same time delay for a command controlling an on/off state of household lights may result in the system executing the command without prompting/validating.

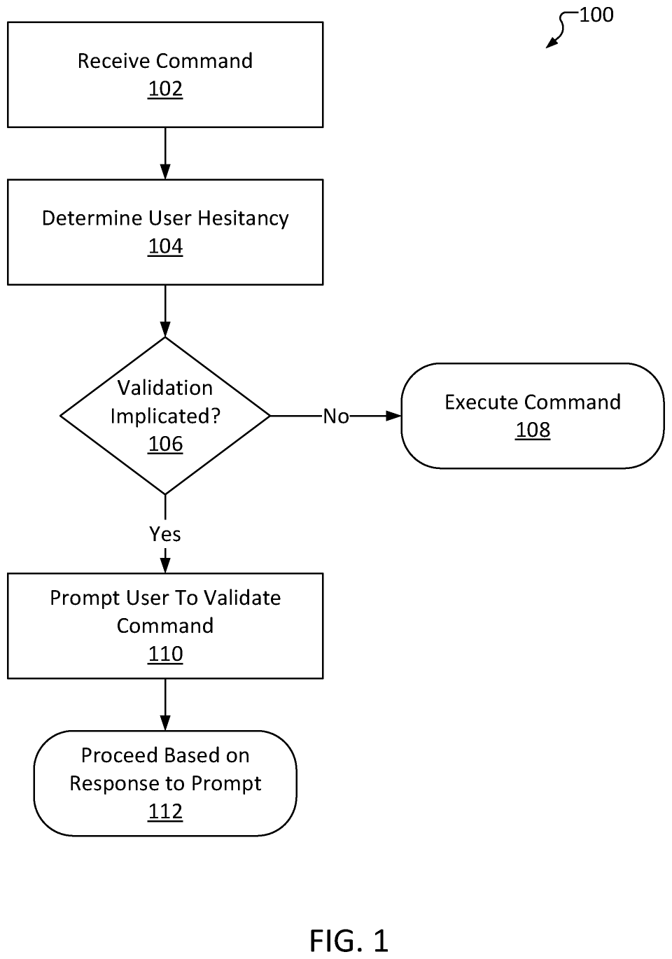

FIG. 1 illustrates a high-level hesitancy-based validation method 100 consistent with several embodiments of the present disclosure. Method 100 may be performed by a system configured to receive commands via user input. For example, method 100 may be performed by a virtual assistant listening for spoken commands, a system managing a website configured to receive commands via a keyboard, etc.

Method 100 includes receiving a command at operation 102. Operation 102 may include, for example, detecting a spoken statement via a microphone and interpreting the statement as a command via one or more language processing algorithms. In some embodiments, operation 102 may include receiving a command via another form of user input, such as a button press (via a keyboard, touchscreen, etc.), a gesture recognized via a camera, etc.

Method 100 further includes determining a user hesitancy score at operation 104. Operation 104 may include, for example, detecting a pause/time delay during receipt of the command of operation 102. For example, if the command is received via a spoken statement, operation 104 may include detecting a pause in the speaker's speech while making the statement.

A pause may be detected as a length of time elapsed without receiving user input. For example, if a user is uttering a voice command, a pause may be detected if the user stops speaking after starting to utter the command but before the user finishes uttering the command. If a user is entering a command via a keyboard, a pause may be detected if the user stops typing prior to submitting the command. Multiple pauses may be detected. Count and duration of pause(s) may be used to calculate a hesitancy score. As a simple example, a hesitancy score may be calculated based on a total length of all detected pauses. In other words, in some embodiments, if a user takes fifteen seconds to utter a voice command but pauses twice, once for two seconds and a second time for three seconds, the hesitancy score may be calculated to be 5. Modifications are possible, such as adjusting the score based on the overall duration of the command (score could be 5/15=⅓), a ratio of pause time to non-pause time (score could be 5/10=0.5), etc.

In some embodiments, operation 104 may only account for the total duration of a spoken statement, without detecting or considering pauses. Returning to the previous example above, in such embodiments the hesitancy score may simply be calculated based upon the “fifteen seconds” value.

A time delay may be detected based on an amount of time elapsed between two or more landmarks. Using the example command “VA, set the oven to six hundred degrees,” a first event may be a user initiating the statement (in this example, “VA”) and a second event may be the end of the command (in this example, the word “degrees”).

In some embodiments, time delay detection can be applied to other forms of input as well. For example, in some embodiments, operation 104 may include detecting a time elapsed between a user entering a value into a text field (such as one presented by a website or computer application) and the user submitting the value (such as by pressing a “submit” button). Other durations may also be considered such as, for example, a length of time elapsed between the user being able to enter values into a field and the user actually entering the values.

Method 100 further includes determining whether a validation is implicated at operation 106. Operation 106 may include, for example, comparing the hesitancy score to a predetermined threshold. In some embodiments, the determination made at operation 106 may be solely based on a hesitancy score threshold comparison. In some embodiments, additional information may be considered, such as severity value described above. Severity value may be determined based on the hesitancy score as well as additional factors such as likelihood of reversal, historical data regarding the command received at operation 102, a security rating of the command, contextual information (such as a user's calendar information), etc.

For example, in some embodiments, a system performing method 100 may determine that the user typically instructs the system to set an oven to four hundred degrees with minimal hesitancy (for example, with no pauses greater than one second). If the system determines that the user's hesitancy value is greater than a typical value (outside a margin of error), this may be interpreted as increasing the likelihood that the user submitted the command in error. Thus, the system may be more likely to determine that a validation is implicated (106 “Yes”) and prompt the user to validate the command at operation 110. On the other hand, the system history may reveal that, even if the hesitancy score is relatively high, previous instances where the system detected similarly high hesitancy values and prompted the user to validate the command resulted in the user confirming the command. Thus, the history may indicate that even a high hesitancy for a particular command may not correspond to a likelihood that the command was in error or would be reversed, and the system may therefore determine that a validation is unnecessary (106 “No”). The system may then proceed to execute the command at operation 108. Operation 108 may include, for example, transmitting instructions to one or more IoT-enabled devices (such as a smart oven, etc.).

In some embodiments, commands may be associated with a particular security rating. For example, as discussed above, bank transfers may be assigned a relatively high security rating while a command to turn household lights on or off may be assigned a relatively low security rating. This security rating may also be considered at operation 106; even if a user's hesitancy is suspiciously high, a command with a particularly low security rating may still be executed without validation. Similarly, even if a user's hesitancy value is relatively low, a higher-risk command (one assigned a high security rating) may still be validated.

If validation is implicated (106 “Yes”), method 100 further includes prompting the user to validate the command at operation 110. Operation 110 may include, for example, causing one or more speakers to emit sound based on an output of a text-to-speech algorithm (such as to ask the user “are you sure?”). The exact nature of the prompt may vary depending upon factors such as the command and/or its security rating, the hesitancy value, etc.

In some embodiments, different security ratings may be associated with different types of validation. For example, a maximum-security command such as a bank transfer may be validated by prompting the user to submit to two-factor authentication, while a lower-security command such as adding a reminder to a user's calendar may be validated by simply asking the user to confirm (where a simple spoken “yes” could be interpreted as a confirmation, for example). In some embodiments, specifics of the command itself may be associated with different types of validation. For example, a command to set a house thermostat to room temperature might only require a spoken “yes” confirmation (if any), while a command to set a house thermostat to over one hundred degrees may require more in-depth validation (such as a biometric validation), as the selected temperature could be dangerous.

In some embodiments, user hesitancy may influence the type of validation prompt as well. For example, a particularly high hesitancy value may result in a system performing method 100 to treat the command as if it were of a higher security rating. As an example, if a user's hesitancy value is significantly higher than is typical for a certain command (such as if the user's spoken instruction took twice as long as usual, as informed by historical data maintained by the system), then even if the command's security rating may typically only require a spoken “yes” to validate the command, the system may require the user to submit a two-factor authentication code.

Further, if a relatively high security rating command is received at operation 102 with a moderate level of user hesitancy, a system performing method 100 may still require validation, but may prompt the user (at operation 110) to validate the command as if it had a lower security rating. This may still advantageously enhance security without needlessly subjecting the user to excessive validation requests.

If the user has been prompted to validate, method 100 further includes proceeding based on a response to the prompt at operation 112. Operation 112 may include, for example, determining whether the user's response has satisfied the conditions required to confirm the command (such as entering the correct two-factor authentication code, orally stating “yes,” etc., depending upon the validation required). If the user has confirmed the command, operation 112 may include executing the command. If the user reverses or cancels the command, operation 112 may include updating a command history database, such as by storing data associated with the received command and the reversal in a database to inform future validation decisions. In some embodiments, “cancelling” the command may simply include doing nothing. In some embodiments, data regarding receipt, validation and execution of commands that were confirmed by the user are also recorded in the database.

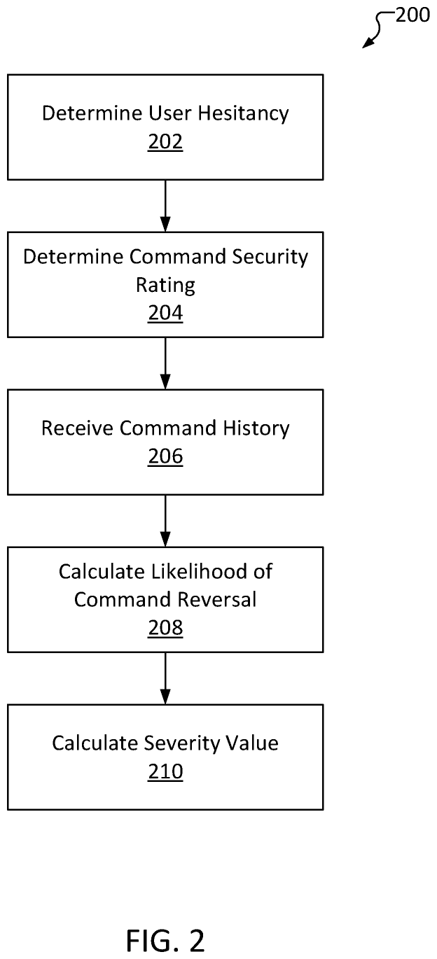

In some embodiments, whether a validation is implicated may be determined based upon more than a hesitancy score. For example, FIG. 2 illustrates an example method 200 of calculating a “severity value” of a received command based upon multiple factors, consistent with several embodiments of the present disclosure. Once calculated via method 200, the severity value can be compared to a threshold to determine whether to validate the command. Method 200 may be performed by, for example, a system configured to receive commands via user input. For example, method 200 may be performed by a virtual assistant listening for spoken commands, a system managing a website or database configured to receive commands via a keyboard, etc.

Method 200 includes determining a hesitancy score of a user issuing a command at operation 202. Operation 202 may include, for example, detecting a pause/time delay during receipt of the command. For example, if the command is received via a spoken statement, operation 202 may include detecting a pause in the speaker's speech while making the statement.

Method 200 further includes determining a security rating of a received command at operation 204. Operation 204 may include, for example, looking up a stored rating (such as searching a database of security ratings using an identifier associated with the received command). Operation 204 may include determining whether a received command is a high-security command, a low-security command, a no-security command, etc. In some embodiments, a user may manually select which security rating to assign to a particular command (for example, a user may configure a system performing method 200 to consider bank transfer commands as “high-security”). In some embodiments, a security rating may be assigned by a device associated with the command (for example, a command to set an oven temperature may be assigned a security rating by the associated oven). In some embodiments, some or all commands may have a “default” security rating.

Method 200 further includes receiving a history of the received command at operation 206. Operation 206 may include, for example, receiving historical data from a database including statistics such as a number of times the command (or the command type) has been received, validated, reversed, and/or executed. Data received at operation 206 may further include information such as hesitancy and/or a user's calendar information at the time of previous instances of the command.

Method 200 further includes calculating a likelihood of reversal of the command at operation 208. Operation 208 may include, for example, comparing historical command reversal data with current data. As an example, if the received command is to set an oven to a particular temperature, operation 208 may include analyzing historical data regarding how often the user has set the oven temperature, what the selected temperature was, the hesitancy score of the user during these past commands, and whether the user reversed or otherwise modified the commands. Based on comparing this information to the current command (including current hesitancy score and, for example, selected temperature for an oven), a system performing method 200 can calculate a likelihood that the command will be reversed if prompted to validate.

In some embodiments, the calculation performed at operation 208 may further consider a statistical analysis of a value included in the command. In other words, operation 208 may further include determining whether a value of the command is within a normal or typical range of values. For example, a user may frequently transfer an amount ranging from $750 US to $1,000 US to a bank account. If a system performing method 200 receives a command from the user to transfer $100,000 US to the same bank account, this may indicate that the amount entered was in error, resulting in a relatively high likelihood of reversal. If the user frequently transfers $100,000 US to the bank account, however, then the likelihood of reversal may not be as high. This statistical analysis may also support determinations of which kind of validation to require, as discussed in further detail below.

Method 200 further includes calculating a severity value for the received command at operation 210. Once determined, the severity value can be compared against a threshold to determine whether a validation is implicated. The severity value is determined based on factors such as the hesitancy score, security rating, and likelihood of reversal. Thus, even if a command has a high likelihood of being reversed in response to a validation prompt, the command's security rating may still result in a severity value below the threshold. Similarly, even if a command has a low hesitancy and likelihood of reversal, the security rating may require validation anyway. Thus, in some embodiments, operation 204 may include checking to see whether the command's security rating has any required action (e.g., “always validate,” “always execute”) and if so, performing that action.

In some embodiments, the risk threshold is constant for all commands. However, in some embodiments, the risk threshold may be different for different commands. For example, the risk threshold may vary based on the security rating, associated device/system identity (oven, thermostat, bank software, etc.), etc. In some embodiments, the user may modify the risk threshold(s) (such as on a per-command basis).

If the severity value is above the threshold, a validation is implicated. In some embodiments, a system performing method 200 may, in response to determining that a validation is implicated, prompt a user to validate the command. In some embodiments, the nature of the prompt depends upon the security rating of the command; higher security commands may require more substantial methods of validation.

More intrusive or disruptive methods of validation may require more attention and/or focus from the user. While this may frustrate some users, it may also increase a likelihood that users will notice an error. For example, if a user is prompted to validate via a simple spoken prompt such as “please confirm” such that the user can validate simply by saying “yes,” the user may opt to double-check the value or reconsider the command, but would not be required to. A higher-security validation may include requiring the user to repeat or re-enter the command, which may force the user to consider the command a second time. Further, if the user misspoke or mis-entered the command due to distraction, more time-consuming validation prompts may have an increased likelihood of regaining the user's attention and thus catching errors. However, users may become frustrated if repeatedly required to perform time-consuming validations for commands that they actually do wish to execute. Thus, determining when to require validation (and what kind of validation to require) can advantageously cause users to catch their own errors without intrusively requiring validation when unnecessary.

In some embodiments, if a validation is implicated, some commands may be treated as if they belonged to a different security level. This may occur, for example, if the hesitancy score associated with the command is significantly outside normal values. In other words, in some embodiments, a low-security command may result in prompting a user to perform a validation method typically associated with higher-security commands (such as a biometric authentication). As an example, a user may utter a voice command instructing a virtual assistant (VA) to set a house thermostat to seventy degrees. Such a command may be categorized as a low-security command, and thus even if a system detected a moderate hesitancy score, the command may not be validated. However, if the user paused for a significant duration while uttering the command (resulting in a correspondingly significant hesitancy value), then the system may, for this instance, consider the command as if it belonged to a higher security rating and prompt the user to validate accordingly.

Similarly, in some embodiments, the method of validation selected (and prompt presented) may be modified. Other factors beyond hesitancy score may also be considered; for example, if a value selected by a user is sufficiently beyond a range of normal or typical values (such as, for example, if the value is over three standard deviations outside a statistical median), then the security rating may be temporarily altered regardless of hesitancy score. Commands outside a normal range may require higher-level authentication for several reasons. For example, in some instances a command way outside the norm could be dangerous (e.g. setting a thermostat to 120 degrees) or costly (e.g., submitting a purchase order for 10,000 of a product rather than 10). As an example, if a user confidently instructs a virtual assistant to set a house temperature to zero degrees, then even if thermostat commands are typically low-security and the hesitancy score is low, the user may still be prompted to validate the command because the selected temperature is so far outside a typical range.

Modifications of security ratings of commands is not necessarily temporary. In some embodiments, security ratings may be modified automatically. For example, if a user frequently reverses a command when prompted to validate, systems and methods consistent with the present disclosure may increase the security rating of the command. Similarly, if a user consistently confirms a particular command regardless of hesitancy score, then the security rating may be decreased. In some embodiments, such modifications may be also performed manually (for example, a user may specifically modify the security rating of a command).

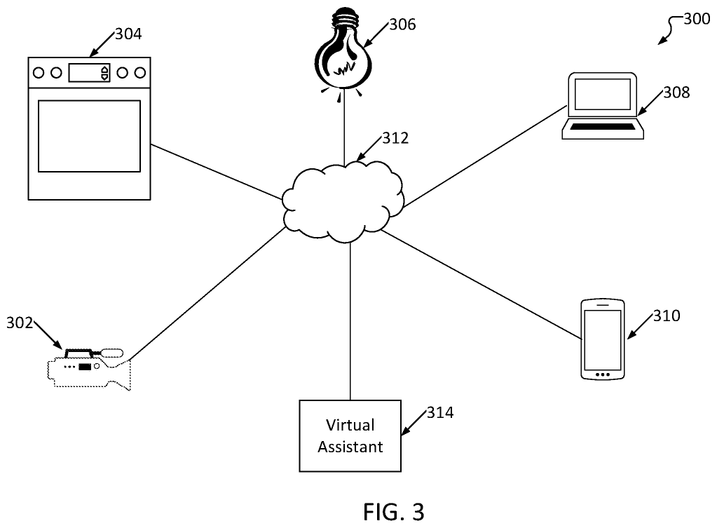

FIG. 3 illustrates an example internet-of-things (IOT) environment 300 which may be managed using hesitancy-based command validation, consistent with several embodiments of the present disclosure. Environment 300 may include several devices such as camera 302, oven 304, light fixture 306, computer system 308, and mobile device 310. These devices may be “smart devices” (in that they may communicate with one another via a network 312). One or more of the devices of environment 300 may be configured to perform hesitancy-based command validation operations, such as those described with respect to FIG. 1 and FIG. 2, above. Commands issued by a user may be received by a virtual assistant 314 in communication with the network 312, enabling the user to control the smart devices via interacting with virtual assistant 314. Note that, in some embodiments, virtual assistant 314 may be implemented elsewhere, such as within one of the smart devices.

As an example, a user may issue a first command to virtual assistant 314 to cause lights 306 to turn off. Virtual assistant 314 may determine that, due to the command being classified as a “never-validate” command, the command should be executed regardless of history, hesitancy, etc., and transmit a signal via network 312 to cause lights 306 to turn off. However, if the user issues a command to cause oven 304 to heat up to 800 degrees, virtual assistant 314 may consider factors such as hesitancy, history, ranges of typical values, etc., and determine that the command should be validated. Virtual assistant 314 may then prompt the user to validate the command (such as by causing a message to appear on mobile device 310 or on computer 308, or by causing a speaker to emit an audible validation request, etc.). If the user validates the command (inputting a validation to one of the smart devices), virtual assistant 314 may then execute the command by instructing oven 304 to heat up to the instructed temperature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

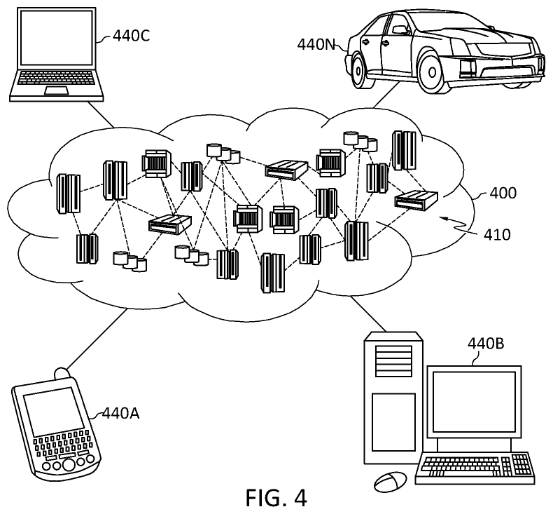

Referring now to FIG. 4, illustrative cloud computing environment 400 is depicted. As shown, cloud computing environment 400 comprises one or more cloud computing nodes 410 with which local computing devices used by cloud consumers, such as, for example, personal digital assistant (PDA) or cellular telephone 440A, desktop computer 440B, laptop computer 440C, and/or automobile computer system 440N may communicate. Nodes 410 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 440A-N shown in FIG. 4 are intended to be illustrative only and that computing nodes 410 and cloud computing environment 400 can communicate with any type of computerized device over any type of network and/or network addressable connection (e.g., using a web browser).

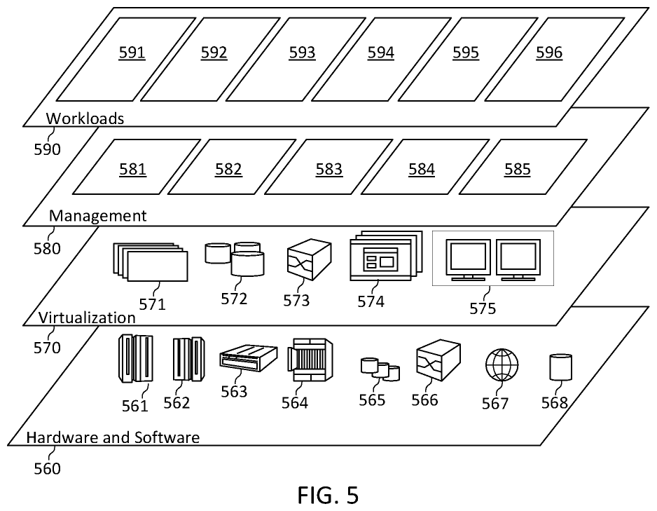

Referring now to FIG. 5, a set of functional abstraction layers provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provide pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: mapping and navigation 591; software development and lifecycle management 592; virtual classroom education delivery 593; data analytics processing 594; transaction processing 595; and hesitancy-based command validation 596.

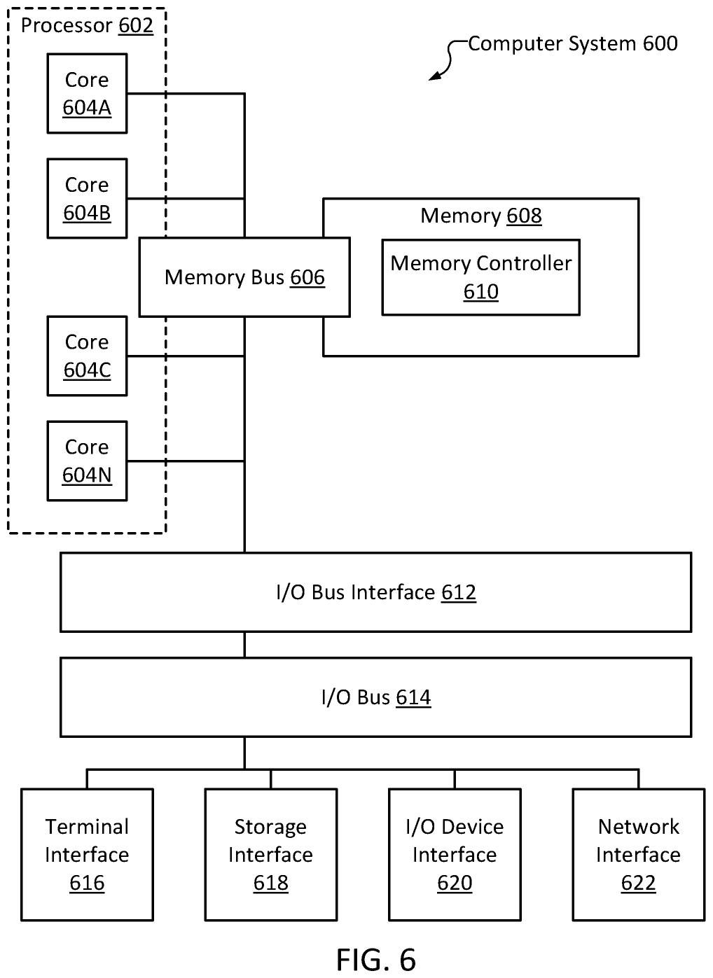

Referring now to FIG. 6, shown is a high-level block diagram of an example computer system 600 that may be configured to perform various aspects of the present disclosure, including, for example, methods 100 and 200. The example computer system 600 may be used in implementing one or more of the methods or modules, and any related functions or operations, described herein (e.g., using one or more processor circuits or computer processors of the computer), in accordance with embodiments of the present disclosure. In some embodiments, the major components of the computer system 600 may comprise one or more CPUs 602, a memory subsystem 608, a terminal interface 616, a storage interface 618, an I/O (Input/Output) device interface 620, and a network interface 622, all of which may be communicatively coupled, directly or indirectly, for inter-component communication via a memory bus 606, an I/O bus 614, and an I/O bus interface unit 612.

The computer system 600 may contain one or more general-purpose programmable central processing units (CPUs) 602, some or all of which may include one or more cores 604A, 604B, 604C, and 604D, herein generically referred to as the CPU 602. In some embodiments, the computer system 600 may contain multiple processors typical of a relatively large system; however, in other embodiments the computer system 600 may alternatively be a single CPU system. Each CPU 602 may execute instructions stored in the memory subsystem 608 on a CPU core 604 and may comprise one or more levels of on-board cache.

In some embodiments, the memory subsystem 608 may comprise a random-access semiconductor memory, storage device, or storage medium (either volatile or non-volatile) for storing data and programs. In some embodiments, the memory subsystem 608 may represent the entire virtual memory of the computer system 600 and may also include the virtual memory of other computer systems coupled to the computer system 600 or connected via a network. The memory subsystem 608 may be conceptually a single monolithic entity, but, in some embodiments, the memory subsystem 608 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 804 may contain elements for control and flow of memory used by the CPU 602. This may include a memory controller 610.

Although the memory bus 606 is shown in FIG. 6 as a single bus structure providing a direct communication path among the CPU 602, the memory subsystem 608, and the I/O bus interface 612, the memory bus 606 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 612 and the I/O bus 614 are shown as single respective units, the computer system 600 may, in some embodiments, contain multiple I/O bus interface units 612, multiple I/O buses 614, or both. Further, while multiple I/O interface units are shown, which separate the I/O bus 614 from various communications paths running to the various I/O devices, in other embodiments some or all of the I/O devices may be connected directly to one or more system I/O buses.

In some embodiments, the computer system 600 may be a multi-user mainframe computer system, a single-user system, or a server computer or similar device that has little or no direct user interface but receives requests from other computer systems (clients). Further, in some embodiments, the computer system 600 may be implemented as a desktop computer, portable computer, laptop or notebook computer, tablet computer, pocket computer, telephone, smart phone, mobile device, or any other appropriate type of electronic device.

It is noted that FIG. 6 is intended to depict the representative major components of an exemplary computer system 600. In some embodiments, however, individual components may have greater or lesser complexity than as represented in FIG. 6, components other than or in addition to those shown in FIG. 6 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method, comprising:
receiving a command from a user;
calculating, based on a time delay of the command, a hesitancy of the user; and
calculating, based on the hesitancy, a severity value of the command;
determining, based on the severity value, whether a validation of the command is implicated; and
prompting, responsive to a determination that a validation of the command is implicated, the user to validate the command.

2. The method of claim 1, further comprising:
receiving a response to the prompting, the response indicating that the command is valid;
executing the command; and
updating a command history database based on:
the command;
the severity value; and
the response.

3. The method of claim 1, further comprising:
receiving a response to the prompting, the response cancelling the command;
cancelling the command; and
updating a command history database based on:
the command;
the severity value; and
the response.

4. The method of claim 1, wherein the determining is further based on a command history database.

5. The method of claim 1, wherein the prompting is based on:
the hesitancy; and
a security level of the command.

6. The method of claim 1, wherein the command includes a value; and
the method further comprises comparing the value to a normal range of values, wherein the determining is further based on the comparison.

7. The method of claim 1, further comprising calculating a likelihood of command reversal, wherein the severity value is further based on the likelihood of command reversal.

8. A system, comprising:
a central processing unit (CPU) including one or more CPU cores, the CPU configured to:
receive a command from a user;
calculate, based on a time delay of the command, a hesitancy of the user; and
calculate, based on the hesitancy, a severity value of the command;
determine, based on the severity value, whether a validation of the command is implicated; and
prompt, responsive to a determination that a validation of the command is implicated, the user to validate the command.

9. The system of claim 8, wherein the CPU is further configured to:
receive a response to the prompt, the response indicating that the command is valid;
execute the command; and
update a command history database based on:
the command;
the severity value; and
the response.

10. The system of claim 8, wherein the CPU is further configured to:
receive a response to the prompting, the response cancelling the command;
cancel the command; and
update a command history database based on:
the command;
the severity value; and
the response.

11. The system of claim 8, wherein the determining is further based on a command history database.

12. The system of claim 8, wherein the prompting is based on:
the hesitancy; and
a security level of the command.

13. The system of claim 8, wherein the command includes a value; and
the CPU is further configured to compare the value to a normal range of values, wherein the determining is further based on the comparison.

14. The system of claim 8, wherein the CPU is further configured to calculate a likelihood of command reversal, wherein the severity value is further based on the likelihood of command reversal.

15. A computer program product, the computer program product comprising a computer readable storage medium having program instructions embodied therewith, the program instructions executable by a computer to cause the computer to:
receive a command from a user;
calculate, based on a time delay of the command, a hesitancy of the user; and
calculate, based on the hesitancy, a severity value of the command;
determine, based on the severity value, whether a validation of the command is implicated; and
prompt, responsive to a determination that a validation of the command is implicated, the user to validate the command.

16. The computer program product of claim 15, wherein the instructions further cause the computer to:
receive a response to the prompt, the response indicating that the command is valid;
execute the command; and
update a command history database based on:
the command;
the severity value; and
the response.

17. The computer program product of claim 15, wherein the instructions further cause the computer to:
receive a response to the prompting, the response cancelling the command;
cancel the command; and
update a command history database based on:
the command;
the severity value; and
the response.

18. The computer program product of claim 15, wherein the determining is further based on a command history database.

19. The computer program product of claim 15, wherein the prompting is based on:
the hesitancy; and
a security level of the command.

20. The computer program product of claim 15, wherein the command includes a value; and
the instructions further cause the computer to compare the value to a normal range of values, wherein the determining is further based on the comparison.
